(19) United States
(12) Patent Application Publication
(10) Pub. No.: US 2014/0254864 A1
(43) Pub. Date: Sep. 11, 2014

(54) SYSTEM AND METHOD FOR GESTURE DETECTION THROUGH LOCAL PRODUCT MAP

(71) Applicant: Google Inc., Mountain View, CA (US)

(72) Inventors: Navneet Dalal, San Francisco, CA (US); Rahul Garg, San Francisco, CA (US); Varun Gulshan, San Francisco, CA (US); Ankit Mohan, San Francisco, CA (US)

(73) Assignee: Google Inc., Mountain View, CA (US)

(21) Appl. No.: 13/788,900

(22) Filed: Mar. 7, 2013

(51) Int. Cl. G06K 9/62; G06K 9/00

(52) U.S. Cl. CPC G06K 9/6267; G06K 9/00335
USPC 382/103; 382/195; 382/170

(57) ABSTRACT

System and method for image detection that include collecting image data; at a processor, over a plurality of support regions of the image data, computing a dimensionality component of a support region of the image data, wherein the, non-nucleus pixels of a support region; calculating a normalizing factor of the dimensionality component; for at least one weighted pattern of a pattern set, applying a weighted pattern to the dimensionality component to create a gradient vector, mapping the gradient vector to a probabilistic model, and normalizing the gradient vector by the normalizing factor; condensing probabilistic models of the plurality of support regions into a probabilistic distribution feature for at least one cell of the image data; applying a classifier to at least the probabilistic distribution feature; and detecting an object in the image data according to a result of the applied classifier.

### TECHNICAL FIELD

This invention relates generally to the gesture detection field, and more specifically to a new and useful system and method for gesture detection through local product maps in the gesture detection field.

### BACKGROUND

Local binary pattern (LBP) operators are often used for texture classification in the computer vision. LBP works through labeling pixels of an image by thresholding pixels in a support region against a nucleus pixel (e.g., center pixel). Where the pixel is greater than the center pixel, the pixel is assigned a one, otherwise the pixel is assigned a zero. A histogram of the frequency of assigned binary pixel values is then computed. The histogram may then also be normalized. The resulting histogram is then used as a feature in classification processes. LBP operators have become a feature for computer vision classification applications; however, LBP features are sensitive to varying lighting conditions and can prove to not be robust in certain applications. Thus, there is a need in the gesture detection field to create a new and useful system and method for gesture detection through local product maps. This invention provides such a new and useful system and method.

### BRIEF DESCRIPTION OF THE FIGURES

FIG. 1 is a schematic representation of a system of a preferred embodiment;

FIG. 2 is a flowchart representation of a method of a preferred embodiment;

FIG. 3 is exemplary performance chart comparing use of localized probabilistic pattern features of a preferred embodiment to local binary pattern features;

FIG. 4 is a exemplary graphical representation of divided image data;

FIG. 5 is a detailed diagram of computing a dimensionality component of a local support region;

FIG. 6 is a schematic representation of computing an exemplary dimensionality vector;

FIGS. 7A-7C are exemplary weighted pattern vectors; and

FIG. 8 is a detailed schematic representation of condensing probabilistic models into a probabilistic distribution feature, where six exemplary patterns are applied to dimensionality components.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. System for Gesture Detection Through Local Product Maps

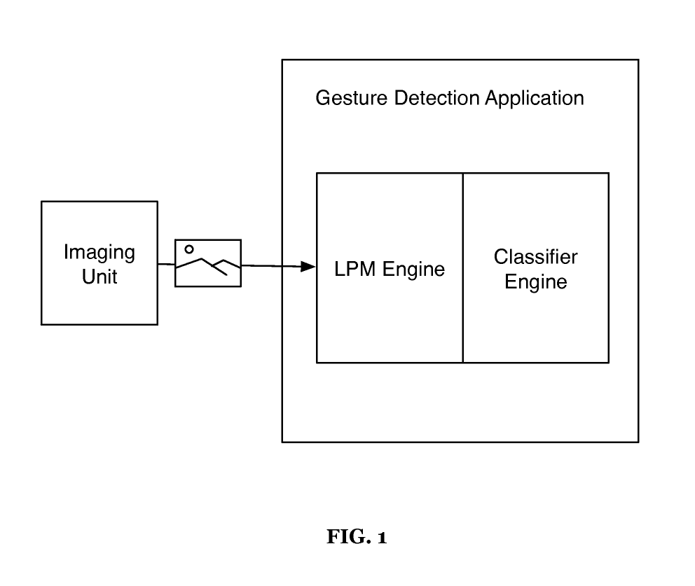

As shown in FIG. 1, a system for detecting gestures through a local product map of a preferred embodiment includes an imaging unit, a local product map (LPM) feature extraction engine, and a classifier engine. The system functions to identify gestures from image data. The system is preferably used in detecting natural body motion gestures such as hand gestures, facial gestures, arm gestures, leg gestures, full body gestures, or any suitable gesture. The gesture detection is more preferably used as gesture-based user input device to control an application or device. Similarly, the system can be extended to other computer vision applications such as facial recognition, object detection, character recognition, and/or any suitable application of image classification. The LPM feature extraction engine preferably enables the system to detect gestures and/or objects with significant improvement over prior techniques such as LBP. The LPM feature extraction engine uses a gradient based, probabilistic modeling in local pixel regions. The output of the LPM feature extraction engine uniquely enables enhanced gesture and/or object recognition. The system may be implemented within an application on a device such as a mobile device, a desktop computing device, or any suitable device. The system may alternatively include components that are at least partially remotely located. For example, the imaging unit may be part of a mobile application while the LPM feature extraction engine and the classifier engine are modules hosted on a server. In an alternative implementation, the system is at least partially integrated into operational components of a processor or hardware component. The system may be integrated at the level of an arithmetic and logic unit, in the memory architecture, in the logic architecture, and/or any aspect of the computer processor.

The imaging unit of a preferred embodiment functions to acquire image data for classification. The imaging unit may directly capture image data or the imaging unit may alternatively interface with a source of image data. An imaging capture unit may capture video or still images with a camera such as a RGB digital, web camera, or a camera phone, but may alternatively be implemented by any suitable imaging unit such as stereo camera, 3D scanner, or IR camera. In one variation, the imaging unit can be directly connected to and/or integrated with a display, user interface, or other user components. Alternatively, the imaging unit can be a discrete element within a larger system that is not connected to any particular device, display, user interface, or the like. Preferably, the imaging unit is connectable to a controllable device, which can include for example a display and/or audio channel. Alternatively, the controllable device can be any suitable electronic device or appliance subject to control though electrical signaling. The image data collected from the imaging unit is preferably directed to the LPM feature extraction engine where the data will be processed and classified. The imaging unit may include a preprocessor module to modify the image data prior to communicating to the feature extraction engine.

The local product map (LPM) feature extraction engine functions to compute a feature based on a product map and probability for the local image data. The LPM feature extraction engine preferably retrieves image data from the imaging unit. The LPM feature extraction engine is preferably configured for computing dimensionality of a local support region, calculating a normalizing term of the dimensionality term, applying weighted patterns to the dimensionality term, mapping to a probabilistic model, and modeling probability distribution as the LPM feature, as described in further detail below. The LPM feature output of the LPM feature extraction engine is preferably a histogram representing probability distribution for various texture patterns. The LPM feature extraction engine preferably preserves the gradient nature of pixel values and maps those into a probability space. The LPM feature extraction engine may additionally account for directionality of the patterns. The LPM features preferably reflect a probability of a region of the image data being of a particular pattern.

The classifier engine of a preferred embodiment functions to use LPM features of the image data to identify gestures and/or objects. The classifier engine preferably includes at least one machine learning or classification module that operates on the LPM features of the LPM feature extraction engine. The classifier engine may be configured to classify any suitable number of gestures or objects. Additional features may be extracted through other engines. The feature outputs of other feature extraction engines may be use in combination with the LPM features. The output of the classifier engine is preferably used in generating gesture input, gesture identification, object identification, and/or any suitable image detection application.

### 2. Method for Gesture Detection Through Local Product Maps

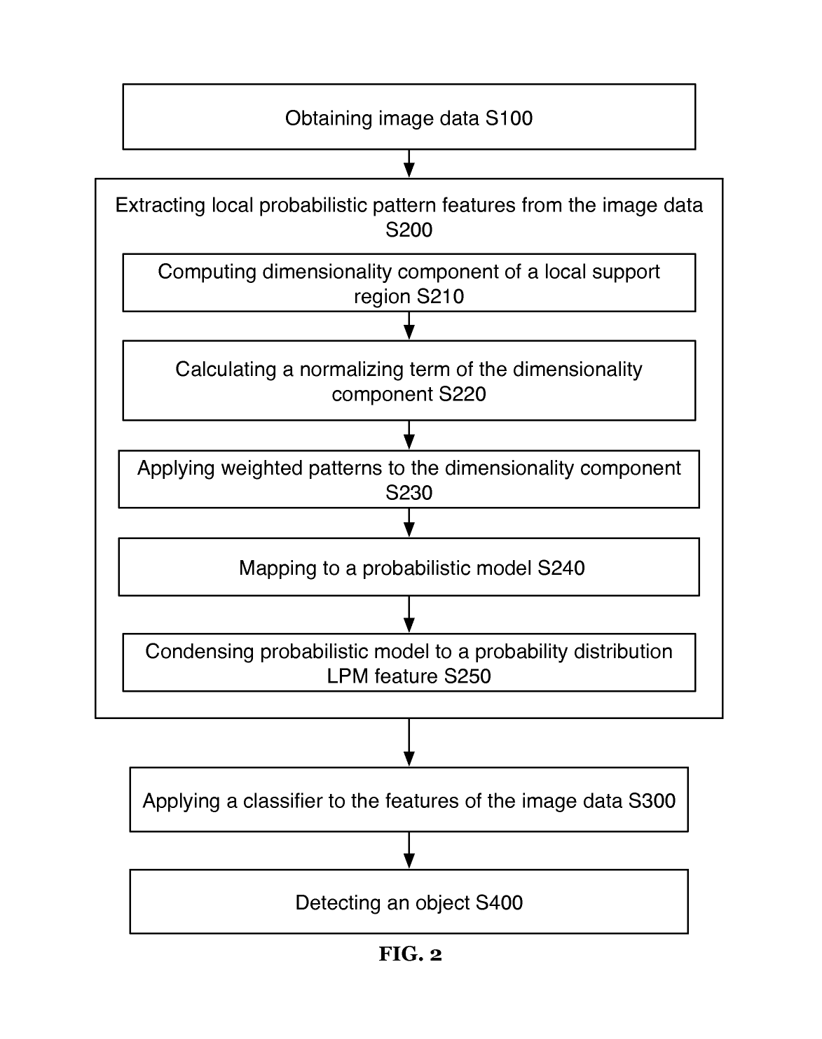

As shown in FIG. 2, a method for gesture detection through local product map (LPM) of a preferred embodiment includes obtaining image data S100, extracting local product map features from the image data S200, applying a classifier to the features of the image data S300, and detecting an object according to the result of the applied classifier S400. Step S200, extracting a LPM feature from the image data, additionally includes computing a dimensionality component of a local support region S210, calculating a normalizing term of the dimensionality component S220, applying a weighted pattern to the dimensionality component to create a gradient vector S230, mapping the gradient vector to a probabilistic model S240, condensing probabilistic models into a probabilistic distribution feature S250.

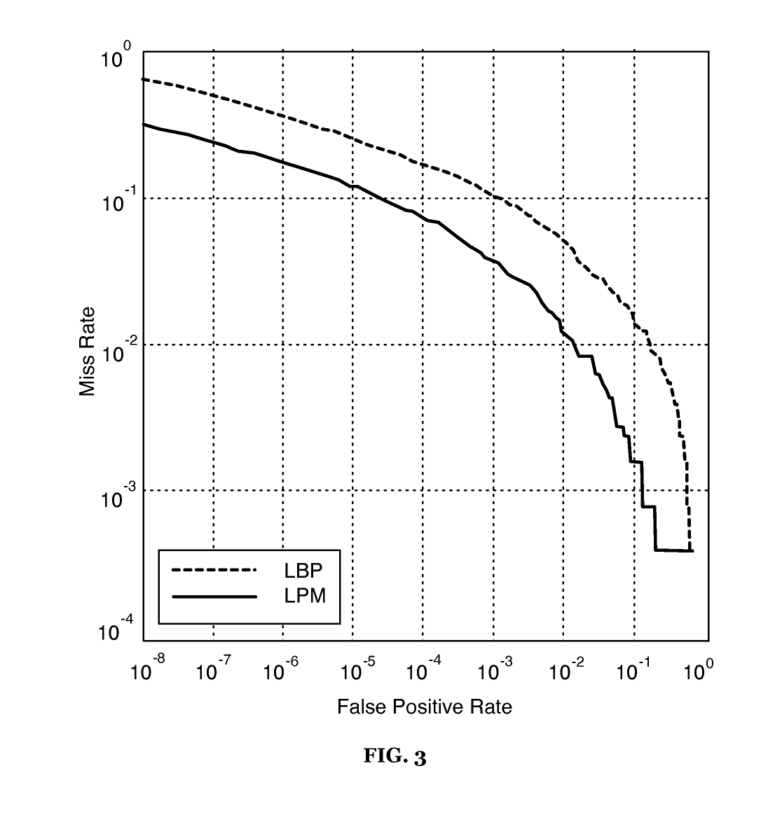

The computed LPM feature preferably preserves the gradient nature of pixel values and maps those into a probability space as opposed to LBP where pixel information is lost in transformation into binary constructs. LBP uses a binary assignment of pixels in a support region based on the pixel wise comparison of pixels, sacrificing image information. The method of a preferred embodiment uses a LPM feature that preserves relative pixel values (i.e., gradient information) and uses a probability based modeling to extract pattern maps. LPM is thus less sensitive to lighting conditions of an image, less sensitive to pixel value variance, and an overall more robust feature for gesture and/or detection. As shown in FIG. 3, performance comparison of a LPM feature implementation of a preferred embodiment to a LBP feature implementation, with x-axis shows false positive rate (i.e. how often a negative examples is wrongly marked as positive class label at any given threshold) and the y-axis measures the miss rate (i.e. how many of true positives were missed at any given threshold), shows significant performance improvement. The LPM feature implementation may achieve ten times better performance than collections of prior features and approximately one hundred times better performance than typical individual features. The improved gesture detection is maintained while still being comparable to LBP in computational complexity. Such a method can result in expanded capabilities of gesture and/or object detection.

The method is preferably used in gesture and/or object detection applications. For example, the method can preferably detect gestures involving finger movement and hand position without sacrificing operation efficiency or increasing system requirements. One exemplary application of the method preferably includes being used as a user interface to a computing unit such as a personal computer, a mobile phone, an entertainment system, or a home automation unit. The method may be used for computer input, attention monitoring, mood monitoring, in an advertisement unit and/or any suitable application.

Step S100, which includes obtaining image data S100, functions to collect data representing physical presence and actions of a user or scene. The images are the source from which gesture input will be generated. Image data may be accessed from a stored image source or alternatively, image data may be directly captured by an imaging unit. Depending upon ambient light and other lighting effects such as exposure or reflection, it optionally performs pre-processing of images. The camera is preferably capable of capturing light in the visible spectrum like a RGB camera, which may be found in web cameras, web cameras over the internet or local Wi-Fi/home/office networks, digital cameras, smart phones, tablet computers, and other computing devices capable of capturing video. Any suitable imaging system may alternatively be used. A single unique camera is preferably used, but a combination of two or more cameras may alternatively be used. The captured images may be multi-channel images or any suitable type of image. For example, one camera may capture images in the visible spectrum, while a second camera captures near infrared spectrum images. Captured images may have more than one channel of image data such as RGB color data, near infra-red channel data, a depth map, or any suitable image representing the physical presence of a objects used to make gestures. Depending upon historical data spread over current and prior sessions, different channels of a source image may be used at different times.

Additionally, the method may control a light source for when capturing images. Illuminating a light source may include illuminating a multi spectrum light such as near infrared light or visible light source. One or more than one channel of the captured image may be dedicated to the spectrum of a light source. The captured data may be stored or alternatively used in real-time processing. Pre-processing may include transforming image color space to alternative representations such as Lab, Luv color space. Any other mappings that reduce the impact of exposure might also be performed. This mapping may also be performed on demand and cached for subsequent use depending upon the input needed by subsequent stages. Additionally or alternatively, preprocessing may include adjusting the exposure rate and/or frame rate depending upon exposure in the captured images or from reading sensors of an imaging unit.

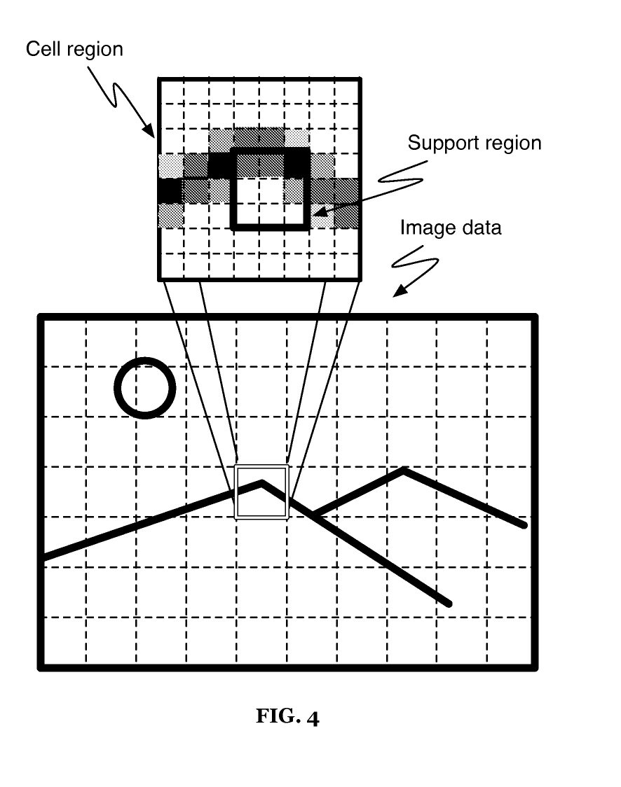

Step S200, which includes extracting a LPM feature from the image data, functions to use a process of pattern predictions from localized regions of pixels. LPM is ideal for texture pattern detection as it can be applied over regional areas. The image data is preferably segmented into different regions of an image. Each region of an image is preferably subdivided into support regions as shown in FIG. 4. A support region is preferably an area of neighboring pixels. Typically the support region is a three by three block of pixels, but may alternatively be a five by five, seven by seven, or any suitable size or dimension of a pixel region. A support region preferably includes a nucleus pixel to which other pixels in the support region are compared. The nucleus pixel is preferably the center pixel of the support region. Alternatively, the nucleus pixel may be any suitably located pixel of the support region, but herein the center pixel alternative is used as the exemplary nucleus pixel location though any suitable location may be used. Larger support regions have more possible patterns and thus can result in more computationally intensive processing. The method may be adapted to account for larger support regions through tiered feature classification, limited pattern detection, and/or any suitable technique. LPM feature extraction is preferably performed on a grayscale version of the image data, but may alternatively be adapted to account for colored images, 4-dimensional image data, video, and/or any suitable image data. Additionally, a variety of feature types can additionally be extracted from the image data, and may be used in any suitable combination with the LPM features. For color images, one implementation may process one LPM feature per channel separately and then either create separate histograms per channel or vote in the one histogram irrespective of the color channel.

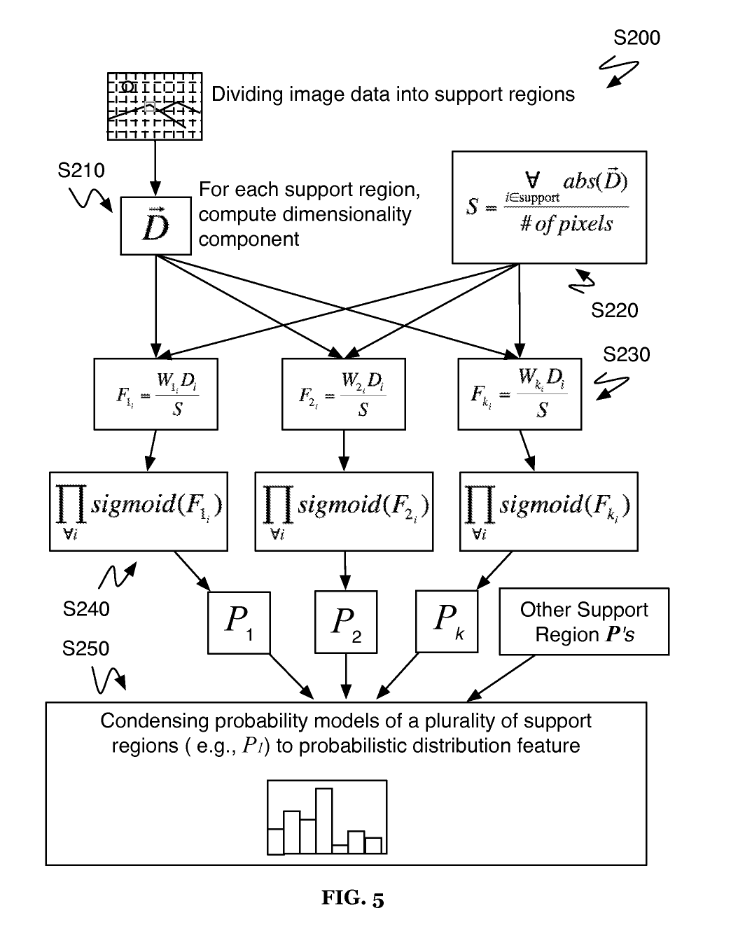

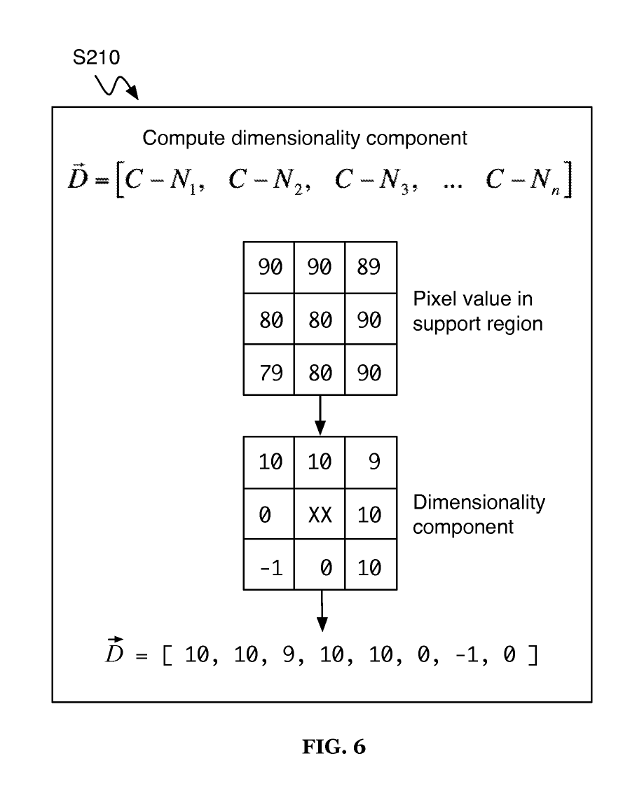

As shown in FIG. 5, Step S200 of a preferred embodiment includes computing a dimensionality component of a local support region S210, calculating a normalizing term of the dimensionality component S220, applying a weighted pattern to the dimensionality component to create a gradient vector S230, mapping the gradient vector to a probabilistic model S240, condensing probabilistic models into a probabilistic distribution feature S250. The process of extracting a LPM feature preferably involves subdividing image data into a plurality of regions. The whole image may be divided or alternatively just a particular region of the image. An LPM feature is preferably generated for different cells, which are regions, composed of at least one support region. Image data may be divided into multiple cells or alternatively a single cell may be used for the entire image. Upon dividing the image data into support regions, each support region will preferably be transformed into a dimensionality vector that characterizes relative pixel values in a support region through step S210. Then for a plurality of patterns in a pattern set, each dimensionality vector is transformed into a probabilistic model through the steps of S220, S230 and S240. Each support region will preferably have a set of probabilistic models where each probabilistic model corresponds to a probability of a pattern for a support region. The full set of probabilistic models, which corresponds to each pattern applied to each support region, is preferably reduced to a histogram model or in other words a probabilistic distribution feature. The probabilistic distribution feature is preferably used as at least a component of the feature extracted for LPM feature extraction. A plurality of LPM features may be generated for a set of image data (e.g., multiple probabilistic distribution features for different cells) or alternatively a single LPM feature may be used. Another preferred variation finds a dimensionality component as in FIG. 6 one for each channel (or at least a subset) and for each dimension. The channel where the absolute of dimensionality is a maximum is preferably selected for use. For example, for a first index of dimensionality component, the result is −5, −2, and 10 as the difference of RGB components respectively, of a pixel with a center pixel. Because 10 is the maximum value, the value 10 is selected as the value that would be used in further computes.

Step S210, which includes computing a dimensionality component of a local support region, functions to calculate relative pixel values of pixels in a region compared to a center pixel. The dimensionality component is preferably a vector (i.e., one dimensional matrix) with n terms for each of the pixels in the support region, where there are n+1 pixels in the support region, the nucleus pixel accounting for the plus one pixel. As shown in FIG. 6, the nth term of dimensionality component is preferably calculated by calculating the difference in pixel value between the nucleus pixel and the corresponding nth pixel. For image data with a pixel value range of zero to a max value, the range of the dimensionality vector component is preferably from negative max pixel value to positive max pixel value. For example, if the pixel value range is from 0 to 255, then the range of the dimensionality vector component is −255 to +255. Using a high range, as opposed to bucketing into binary “greater than” and “less than” categories, the relative scale of pixel values is preserved. Pixel value is preferably the value of a pixel such as the value assigned to a pixel in a grayscale image. However, the pixel value may alternatively be a channel of the pixel image data (e.g., red value for an RGB image), or any suitable value derived from image data. A dimensionality component is preferably calculated for each support region used in extracting a LPM feature.

Step S220, which includes calculating a normalizing term of the dimensionality component, functions to generate a factor by which subsequent calculations may be normalized. In one preferred embodiment, the normalization term is the absolute average of the terms in the dimensionality vector component as shown in FIG. 5. The normalization term can be computed by calculating by the sum of the absolute value of each element of the dimensionality vector and dividing by the number of elements in the dimensionality vector (e.g., the number of non-nucleus pixels in the support region). The normalizing term may alternatively be a median value, root mean square, average of L2 norm, or any suitable normalization factor. The support region used to calculate the normalizing term can be the dimensionality vector for each pixel in the cell or a subset of the cells, or even extend beyond the subcell. The normalizing term may be a function of how small a lighting variation can be.

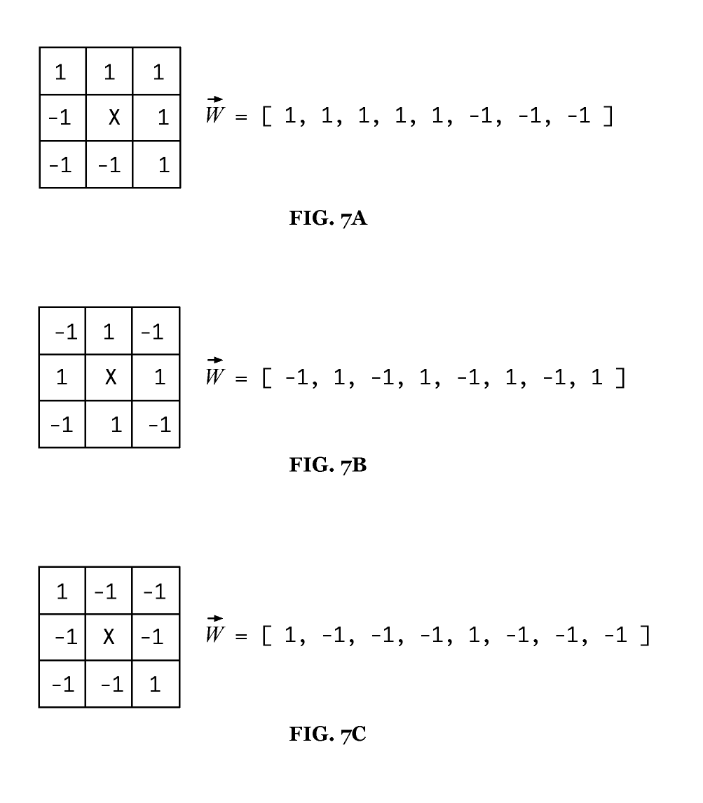

Step S230, which includes applying weighted patterns to the dimensionality component to create a gradient vector, functions to map at least one pattern to the support region. Step S230 is preferably applied in combination with step S240 for each weighted pattern of a pattern set, and Steps S230 and S240 are further repeated for each support region used to calculate the LPM feature. A weighted pattern is preferably a construct that is tailored to incorporating detection of a particular pixel pattern (e.g., a line or two lines intersecting). A first weighted pattern is preferably composed as an n by 1 vector. In a preferred variation, the values of the weighted pattern vector exist in the range of negative one to positive one, but the weighted pattern vector may have any suitable range (e.g., negative infinity to positive infinity). The weighted patterns of the pattern set may be the full permutation of pattern possibilities. Alternatively, the weighted patterns may be a selected subset of pattern possibilities. As another alternative, the weighted patterns may be algorithmically learned, wherein a selected subset of pattern possibilities is determined according to machine learning or other processes. The subset of pattern possibilities is preferably the set of patterns that were historically more influential in matching patterns. For example, weighted patterns may be selected to identify corner as shown in FIG. 7A, a two-line intersection as shown in FIG. 7B, and a line pattern as shown in FIG. 7C. The selected patterns preferably correlate to patterns of interest for gesture detection, and may be any suitable collection of patterns. Each weighted pattern vector and the dimensionality component are preferably multiplied in an element-wise manner (i.e., multiplying the i^{th} element of the weighted pattern by the i^{th} element of the dimensionality component) and divided by the normalizing term, as shown in FIG. 5. The result is a gradient vector characterization of the support region. A gradient vector characterization may alternatively be calculated in any suitable manner.

Step S240, which includes mapping the gradient characterization to a probabilistic model, functions to transform the gradient characterization component to a probability space. The gradient characterization is preferably a gradient vector. Each weighted pattern from the pattern set preferably corresponds to one gradient vector, and thus a probabilistic model (e.g., probability value) is preferably calculated to correspond to each weighted pattern. The gradient characterization generated in Step S230 is preferably transformed into a probability value ranging from zero to one, but the gradient characterization may alternatively be transformed to any suitable range or mapping A probability value is preferably generated by calculating the product of an activation function of each term of the gradient vector. As shown in FIG. 5, one preferred implementation the activation function is a sigmoid function, such that the probability value is generated by calculating the product of the sigmoid of each term of the gradient vector. Put another way mapping the gradient characterization to a probabilistic model may include calculating an activation set (e.g., a sigmoid set) wherein each element of the activation set is the activation function result of an element of the gradient vector; and calculating the probabilistic model from the product of the elements of the activation set. The sigmoid activation function transforms the values of the gradient characterization to a value from 0 to 1, where a value of 0 corresponds to the pixel having 0% probability of matching the pattern (i.e., the pattern corresponding to the weighted pattern used in step S230) and where a value of one corresponds to the pixel having 100% probability of matching the pattern. The preferred sigmoid function is preferably defined for all real values, for all real values has a value from zero to one, and is calculated as the inverse of the sum of one and the exponential of the negative value of an element of the gradient vector as shown below, where Fᵢ is the i^{th} term of the gradient vector:

$$sigmoid ( {F}_{i} ) = \frac{1}{1 + exp ( - {F}_{i} )}$$

The sigmoid computation may also be sped up in the case when the weights are +1 and −1 by observing that sigmoid(−x)=1−sigmoid(x). Integrating such a computational observance into the calculation of a sigmoid can avoid expensive exponentiation in the sigmoid function. Exponentiation may be further optimized by using a lookup table. The sigmoid activation function may alternatively be any suitable variation of a logistic function, arctangent, hyperbolic tangent, algebraic function or any suitable function transformed such that the minimum output of the activation function is preferably a non-negative value. Other activation functions may include max (0,Fᵢ) or log(i+exp(Fᵢ)) or any suitable activation function. Alternatively, any suitable transform may be applied. Such a probabilistic mapping functions to make pixel values more resilient to slight value variations. Instead of drastically altering pattern matching, the probability of matching a pattern changes in relationship to variation of pixels conforming to a pattern. Such resilience makes LPM features more robust in situations such as varied lighting conditions.

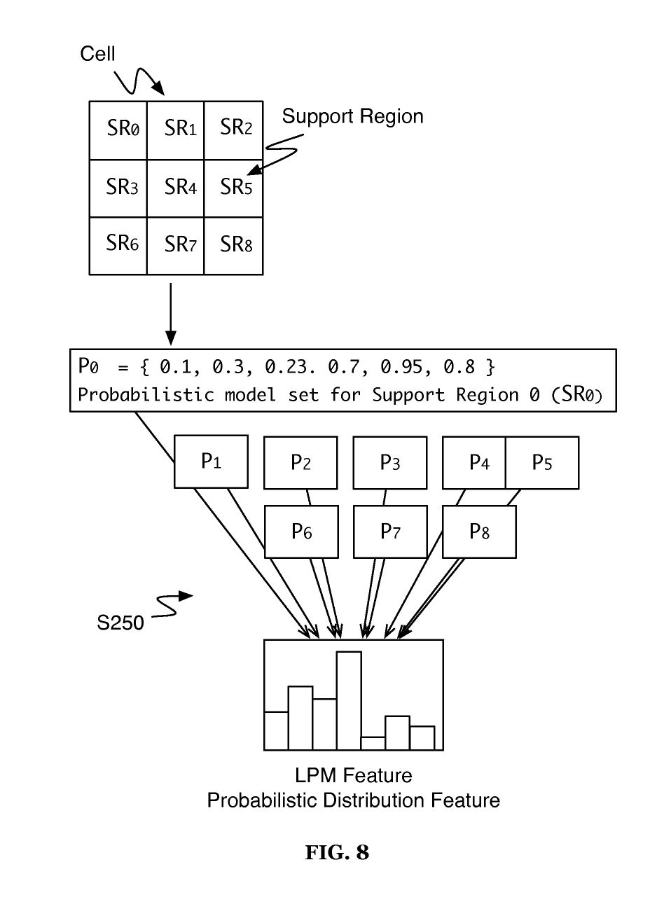

Step S250, which includes condensing probabilistic models into a probabilistic distribution feature, functions to convert the probabilities to histogram based feature. The probability distribution is preferably a histogram-based representation of the probabilistic models over a cell region as shown in FIG. 8. The histogram preferably shows the combined probability of each pattern for the pixels of a cell region. The cell regions is preferably a larger support region that encompasses at least one support region. The support regions of a cell region may have any suitable overlap and/or arrangement within the cell region. For example, if the initial support region used in Steps S210 is three by three pixels, then the cell region may be eight by eight. The histogram may additionally be normalized by computing an L1 norm, L2 norm, or using any suitable normalizing technique. The histogram-based probabilistic distribution feature is preferably used as the LPM feature.

In one preferred implementation of extracting a LPM feature from the image data, the LPM feature may be efficiently computed in the case when the weighted patterns consist of all possible combinations of 1 and −1 (i.e., 2̂n different weight patterns for a length-n pattern). While a simplistic implementation may involve n*2̂n multiplications, a preferred implementation reduces multiplications to 2̂(n+1) by using a dynamic programming based approach that reuses multiplications across different patterns. The approach may be visualized by a binary tree of height n. At a node at level k, the value for the left child is generated by multiplying the value at the node by a sigmoid (or an appropriate activation function) of k-th value in gradient vector weighted by i. Similarly, a weight of −1 is used to generate the value at the right node. Starting with a value of 1 at the root node and generating the tree to depth n, the products corresponding to 2̂n weight patterns are then generated at the leaves of the tree. The number of multiplications can be further reduced by skipping computation of a sub-tree rooted at a node where the value has fallen substantially near zero since all subsequent products will be zero too. Further, the entire tree may not be stored in memory as computation of a single level of the tree can be computed from the previous level. Hence, the approach may not require additional memory and the 2̂n products can be computed in-place. The approach is preferably applicable whenever it is possible to share multiplications across weight patterns beyond the specific case of +1/−1 weights discussed here.

Step S300, which includes applying a classifier to the LPM features of the image data, functions to compute feature similarities and patterns. The classifier preferably uses common machine learning and/or other classification techniques to classify the image data. The classifier may be a support vector machine (SVM), a k-NN classifier, self-organizing map (SOM), statistical test, and/or any suitable machine learning technique or classifier. A classifier may additionally be applied for each gesture and/or object that the method is configured to detect. The classifiers may use a variety of techniques depending on the intended gesture and/or object. A variety of additional features and classification of those features may additionally be performed, and the image data may have a plurality of classifications based on a variety of features at least one of the features being LPM features. A combination of classifiers may be used to detect a plurality of gestures and/or objects.

Step S400, which includes detecting an object according to the result of the applied classifier, functions to respond to the classifications of the image data. In one preferred embodiment, gesture detection is used as a user-interface input mechanism. Upon detecting a configured gesture, a corresponding action or actions are performed by the application and/or device. The gesture input application is preferably substantially similar to the system and method described in U.S. patent application Ser. No. 13/159,379, filed 13 Jun. 2011, which is hereby incorporated in its entirety by this reference. In an alternative preferred embodiment, the gesture detection is used in an informational application. Upon detecting an object or gesture, a data object is augmented (e.g., created, edited, deleted) to reflect the detected gesture. Such an application may be used for tracking or logging detection of a gesture. The detected gesture may alternatively be used in any suitable application.

The system and method of the preferred embodiment and variations thereof can be embodied and/or implemented at least in part as a machine configured to receive a computer-readable medium storing computer-readable instructions. The instructions are preferably executed by computer-executable components preferably integrated with an imaging unit, an LPM feature extraction engine, and a classification engine. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Although omitted for conciseness, the preferred embodiments include every combination and permutation of the various components and steps of the system and method of the preferred embodiments.

As a person skilled in the art will recognize from the previous detailed description and from the figures and claims, modifications and changes can be made to the preferred embodiments of the invention without departing from the scope of this invention defined in the following claims.

What is claimed is:

1. A method for image detection comprising:
collecting image data;
at a processer, over a plurality of support regions of the image data, computing a dimensionality component of a support region of the image data, wherein the dimensionality component characterizes the relative pixel value of a nucleus pixel to the non-nucleus pixels of a support region;
for at least a subset of weighted patterns of a pattern set, applying a weighted pattern to the dimensionality component to create a gradient vector, and mapping the gradient vector to a probabilistic model;
condensing probabilistic models of the plurality of support regions into a probabilistic distribution feature for at least one cell of the image data;
applying a classifier to at least the probabilistic distribution feature; and
detecting an object in the image data according to a result of the applied classifier.

2. The method of claim 1, wherein the computed dimensionality component of each support region is a dimensionality vector wherein each element of the dimensionality vector is the difference in pixel value between a nucleus pixel and a pixel of a support region that is of the same index as the index of the element of the dimensionality vector.

3. The method of claim 2, wherein the weighted pattern is a pattern vector of element weights, and wherein applying a weighted pattern to the dimensionality vector comprises multiplying each element of the dimensionality vector by a corresponding element of the pattern vector.

4. The method of claim 3, wherein the probabilistic distribution feature is a histogram-based feature.

5. The method of claim 4, wherein mapping the gradient vector to a probabilistic model comprises calculating an activation set wherein each element of the activation set is the sigmoid of an element of the gradient vector; and calculating the probabilistic model from the product of the activation set.

6. The method of claim 5, wherein the sigmoid of an element of the gradient vector is calculated as an inverse of the sum of one and the exponential of the negative value of the element of the gradient vector.

7. The method of claim 5, wherein the sigmoid of the elements of the gradient vector is bounded by zero and one.

8. The method of claim 5, further comprising calculating a normalizing factor of the dimensionality component; and applying a weighted pattern to the dimensionality vector to create the gradient vector further comprises normalizing the gradient vector by the normalizing factor.

9. The method of claim 8, wherein the normalizing factor of the dimensionality component further comprises calculating the sum of the absolute value of each element of the dimensionality vector and dividing by the number of elements in the dimensionality vector.

10. The method of claim 8, further comprising normalizing the histogram by a histogram normalization factor.

11. The method of claim 8, wherein the support region is a three by three region of pixels and the nucleus pixel is the center pixel.

12. The method of claim 8, wherein elements of the pattern vector exist in the range of negative one to positive one.

13. The method of claim 8, wherein the pattern set includes pattern vectors that are a subset of the possible pattern vectors for a support region.

14. The method of claim 8, wherein, applying a classifier to at least the probabilistic distribution feature comprises applying a support vector machine classifier to at least the probabilistic distribution feature.

15. The method of claim 8, wherein detecting an object in the image data according to a result of the applied classifier comprises detecting a gesture; and further comprising triggering an application response to the detected gesture.

16. The method of claim 8, further comprising augmenting a data object of an application to reflect the detected object.

17. A method for image detection comprising:
collecting image data;
at a computer processor, extracting a local product map (LPM) feature from the image data, wherein extracting an LPM pattern feature comprises:
over a plurality of support regions of the image data, computing a dimensionality vector from the difference in pixel value between a nucleus pixel and non-nucleus pixels of a support region,
calculating a normalizing factor of the dimensionality vector,
for at least a subset of weighted pattern vectors of a pattern set, creating a gradient vector by multiplying elements of a weighted pattern vector and elements of the dimensionality vector,
normalizing the gradient vector by the normalizing factor,
calculating a activation set wherein each element of the activation set is the sigmoid of an element of the gradient vector,
calculating a probabilistic model from the product of the elements of the activation set, and
condensing probabilistic models of the plurality of support regions into a histogram-based LPM feature for at least one cell of the image data; and
applying a classifier to at least the probabilistic distribution feature; and
detecting an object in the image data according to a result of the applied classifier.

18. The method of claim 17, wherein detecting an object in the image data according to a result of the applied classifier comprises detecting a gesture; and further comprising triggering an application response to the detected gesture.

19. The method of claim 17, further comprising augmenting a data object of an application to reflect the detected object.

20. A system for detecting gestures comprising:
an imaging unit that collects image data;
feature extraction engine on a processor, coupled to an image data output by the imaging unit, and configured with computer program instructions to:
over a plurality of support regions of the image data, compute a dimensionality vector from the difference in pixel value between a nucleus pixel and non-nucleus pixels of a support region,
for a subset of weighted pattern vectors of a pattern set, create a gradient vector by multiplying elements of a weighted pattern vector and elements of the dimensionality vector,
normalize the gradient vectors by a normalizing factor,
calculate a sigmoid set wherein each element of the sigmoid set is the sigmoid of an element of the gradient vector,
calculate a probabilistic model from the product of the elements of the sigmoid set, and
condensing probabilistic models of the plurality of support regions into a histogram-based probabilistic distribution feature for at least one cell of the image data; and
a classification engine computed to a probabilistic distribution feature out of the feature extraction engine.
